(19) United States
(12) Patent Application Publication
(10) Pub. No.: US 2016/0179845 A1
(43) Pub. Date: Jun. 23, 2016

(54) ENHANCED VIEWING OF IMAGES IN CONTENT

(71) Applicant: Microsoft Technology Licensing, LLC, Redmond, WA (US)

(72) Inventors: Bao Nguyen, Bellevue, WA (US); Kun Cong, Sammamish, WA (US); Kasi Sambandam, Bellevue, WA (US); Jane Park, Seattle, WA (US); Jun Yin, Bellevue, WA (US); Amit Velingkar, Bellevue, WA (US)

(21) Appl. No.: 14/580,205

(22) Filed: Dec. 22, 2014

(51) Int. Cl. G06F 17/30; G06F 17/22; G06T 11/60

(52) U.S. Cl. CPC G06F 17/30247; G06T 11/60; G06F 17/2247; G06F 17/30867

(57) ABSTRACT

Images that appear in content are often of low quality, so there may be reason to provide higher quality images to a user. When content, such as a web page, is detected as having an image, a system may generate a query that can be used to retrieve the image from a search engine. The query also causes the search engine to identify other images, which, since they satisfy the query, may be similar to the original image. An interface may be presented to the user that presents these alternative images. In this way, the user can be shown images that are similar to that which the original content author wanted the user to see, but where the additional images may be of higher quality.

### BACKGROUND

It is normal for content, such as web pages and other Internet content, to include images. However, in many cases, the images included in the content are of low quality, even if similar, but higher-quality, images are available. For example, an article on polar bears might have a low-resolution image of a polar bear, even if higher-resolution images of polar bears are available.

A user who wants to see higher quality images can perform an image search, and can even filter the search results based on resolution of the image. In one example, the user can even enter the Uniform Resource Locator (URL) of the image into a search engine, thereby retrieving the original image and, possibly, a set of “visually similar” results.

### SUMMARY

When an image appears in content, the presence of the image may be detected, and the user may be offered the opportunity to view similar (but possibly higher-quality) images. In order to offer additional images to a user, a system first detects the presence of an image in some piece of content. For example, a browser plug-in or control may detect the presence of an image in a web page. The system may then generate a query that is formulated such that, when entered into a search engine, will cause the search engine to retrieve the image as one of the results. Since the query causes a search engine to identify the image, the same query may cause the search engine to identify similar images as part of the results. Thus, the images that are returned to the user as results may be presented to the user for viewing.

In one example, the interface that is used to present the images is an overlay. For example, when an image appears in content, a hook such as a plus sign may be displayed in a corner of the image. If the user hovers over or clicks the hook, then the overlay may appear, partially occluding the original content. The overlay may contain functionality that allows the user to scroll through the various images that were returned in response to the constructed query. When the user closes the overlay, the overlay disappears and the user resumes viewing the original content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of example content that may contain an image.

FIG. 2 is a block diagram of an example overlay that may be used to show images.

FIG. 3 shows an example process that may be used to enhance image viewing.

FIG. 4 is a block diagram of an example scenario in which image viewing is enhanced.

FIG. 5 is a block diagram of example components that may be used in connection with implementations of the subject matter described herein.

### DETAILED DESCRIPTION

In the early days of the internet, users were likely to be satisfied to be able quickly to receive textual information on a subject of their choosing. As the internet has become a more mature technology, and users have become more demanding, the use of images in content has become nearly de rigueur. As a result, there has been an increase in the number of ways to incorporate images into content, as well as in the number of ways to categorize images and to search for them.

One issue that arises when viewing images in internet content is that the images may be of low quality or of low resolution, and the quality or resolution may be incommensurate with the quality of the underlying content that is provided with the images. For example, a web page on polar bears might have excellent textual content, but might include an image of a polar bear with a resolution of 100×200 pixels. On a laptop or tablet screen of typical size, this resolution is barely enough to see what a bear looks like. The reason this situation occurs is that the image that appears in the content is generally chosen by the creator of the content, and is therefore subject to considerations such as which images are available at the time the content is created, and the time and motivation of the content creator to find higher quality images.

A user who wants to see higher quality images can perform an image search, and can even filter the search results based on resolution of the image. In one example, the user can even enter the Uniform Resource Locator (URL) of the image into a search engine, thereby retrieving the original image and, possibly, a set of “visually similar” results. However, this process involves a separate step on the part of the user. The technique of identifying the image and finding visually-similar images results in a reduced amount of physical interaction between the user and the computer or other device—e.g., the user can find the images in fewer keystrokes, few mouse clicks, fewer taps, swipes, or other gestures, etc.

The subject matter herein provides a way to enhance image-containing content with different images, which may be of higher quality than the images that appear in the content. When content is provided to a user (e.g., in the form of a web page, in the form of content delivered by an application, etc.), the presence of an image in the content is detected. A query is then created. The query has the property that, if the query is carried out by a search engine, the image that appears in the content appears (or is likely to appear) high in the search results. It is presumed that a query with this property (and, possibly, certain other properties that are discussed below) can be used to locate images that are similar to the image that appears in the original content.

The images that are located may be displayed to a user in some manner. In one example, when an image is detected, an icon is displayed over the image, and, when the user hovers over the icon, an overlay is displayed that allows the user to browse the similar images that have been found. In one example, the images that are provided for browsing in the overlay are chosen to be of higher resolution than the original image that appeared in the content, although the images may be chosen based on any criteria. In the overlay, the browsable images may be provided in reduced form (e.g., as thumbnails); the user may select one of the thumbnails in order to see the detailed, larger version of the image. When the user is finished browsing images, the overlay may disappear from the interface, thereby returning the user to the original content that he or she was viewing.

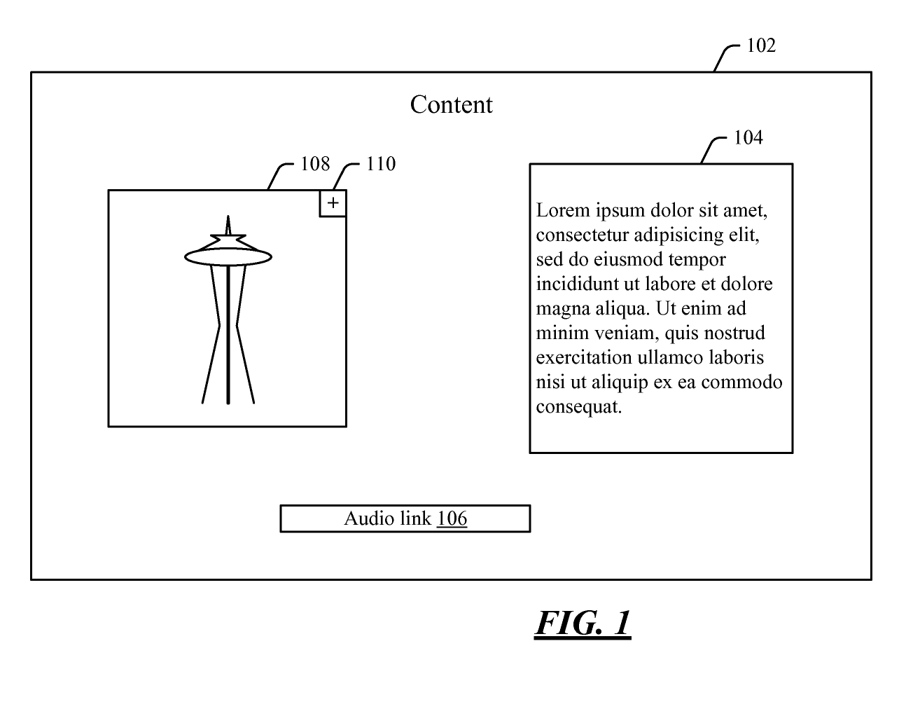

Turning now to the drawings, FIG. 1 shows an example of content 102 that may contain an image, and in which the techniques provided here may be used. In the example shown, content 102 is a web page, although content 102 could take other forms. For example, content 102 could be a screen of content displayed by an application, such as a search application, an image management application, etc. Content 102 contains various content components, such as one or more of text 104, audio link 106, and image 108. The foregoing are examples of content components, since content 102 could contain any types of content components.

While image 108 is merely one example of a content component, for the purpose of the subject matter herein it may be treated in a specific way. In particular, software on the device on which content 102 is being displayed may analyze content 102 and detect the presence of image 108. In one example, the content is being viewed through a browser, and the software that detects the presence of an image is a plug-in or control in the browser, or the browser software itself; however, it will be understood that these examples are non-limiting. There are various ways to detect the presence of image 108 in content 102. In one example, image 102 is identified through the existence of a link to an image file (e.g., a file with an extension such as “.jpg”). In another example, image 108 is embedded in the content and can be identified through analysis of the content. The subject matter herein covers all appropriate ways of detecting the presence of image 108.

Once the presence of image 108 is detected, hook 110 may be displayed over or near image 108. In the example shown, hook 110 takes the form of a plus sign, although other symbols (e.g., a magnifying glass, a spotlight, etc.) could be used. Hook 110 can be activated by an appropriate user interface (UI) mechanism—e.g., clicking, tapping, hovering, etc. In one example, hook 110 is activated by the user's hovering over hook 110 with a pointing mechanism for some amount of time.

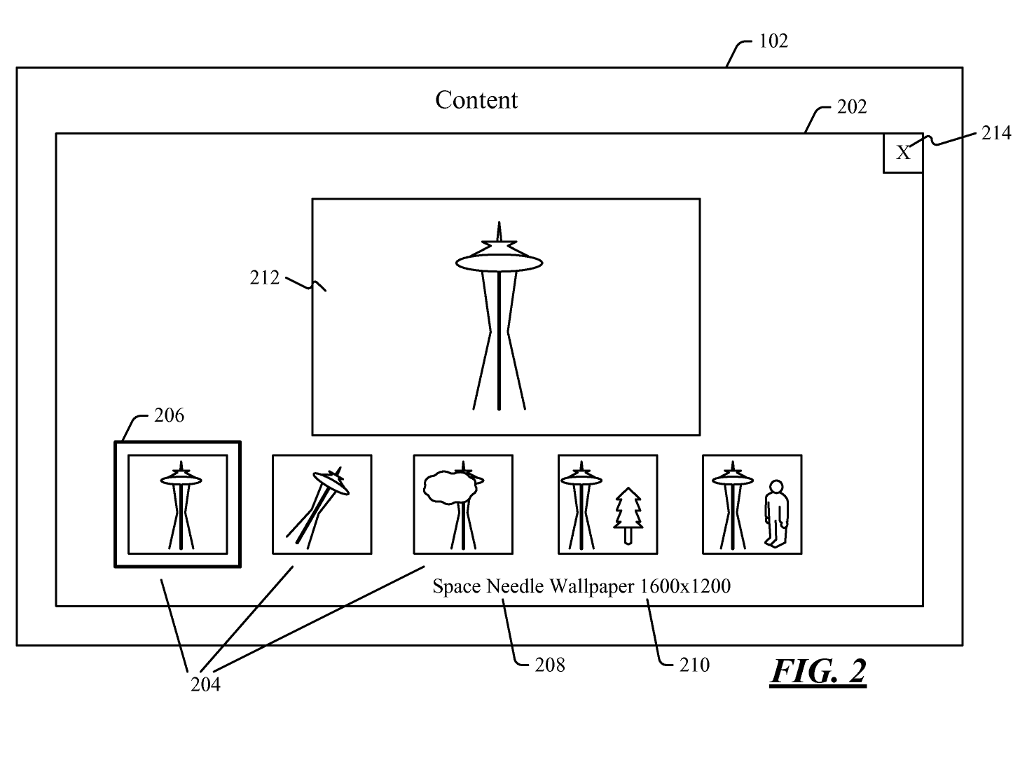

In the example shown in FIG. 1, image 108 is of Seattle's Space Needle. Thus, a system that implements the subject matter herein may search for other images of Space Needle, and may present these images in an overlay. An example of such an overlay is shown in FIG. 2.

FIG. 2 shows the content 102 from FIG. 1, partially occluded by overlay 202. In the example shown, overlay 202 is opaque and completely obscures the region of content 102 that coincides with overlay 202, although overlay 202 could have an arbitrary degree of transparency. E.g., overlay 202 could have a 50% level of transparency that allows a version of content 102 to be shown through overlay 202. Overlay 202 shows one or more images 204, which have been determined (though a process described below) to be images of the same object shown in image 108 (shown in FIG. 1). Thus, images 204, in this example, are images of Space Needle. In the non-limiting example shown, images 204 are shown at thumbnail size.

In the UI of overlay 202, one of the images is highlighted, which, in this example, is image 206. Overlay 202 may include a legend 208, which identifies the highlighted image. In this example, legend 202 identifies the highlighted image as being “Space Needle Wallpaper 1600×1200.” In the example shown, legend 208 identifies the resolution 210 of the highlighted image, which may aid the non-limiting goal of helping the user to find higher-resolution or higher-quality images than that which appear in the original content.

Overlay 202 may also show image 212, which is a larger version of the highlighted image. The user may change which image is being highlighted by scrolling through images 204 (e.g., clicking or hovering over other images, using a wheel on a pointing device, using keyboard arrows, etc., to move through these images). When the user changes the highlighted image, the legend may change to indicate the currently-highlighted image, and the image that is shown in large form may also change to match the highlighted image.

Overlay 202 may also include a closing UI element 212 (such as an “X”, as shown in the example of FIG. 2), which allows the user to close the overlay. When the user closes or minimizes the overlay, the overlay may disappear from the screen, thereby allowing the user to return to viewing the original content 102 (shown in FIG. 1).

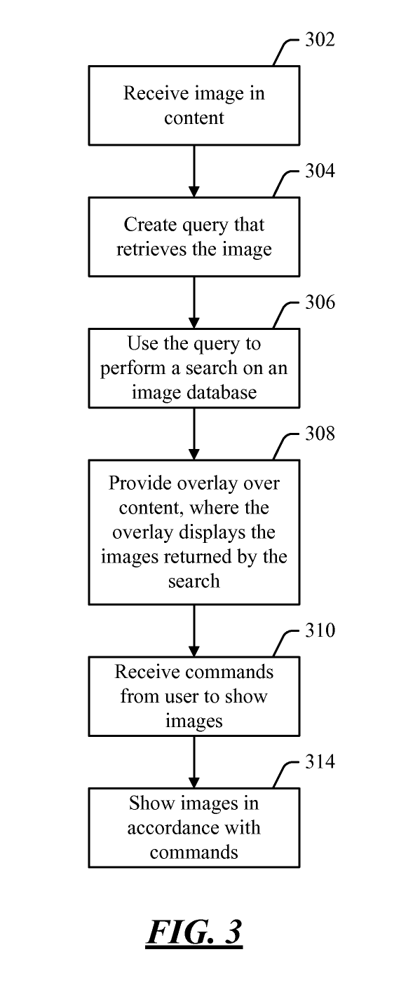

FIG. 3 shows an example process that may be used to perform enhanced image viewing. At 302, an image is received as part of some content. The content may be a web page, or may be some other type of content, such as a unit of information delivered by any type of application. At 304, a query that retrieves the image is created. The query may be constructed so that the image from the content appears at or near the top of the search results when the query is executed. (In one example, the query is constructed with the goal of producing the original image as the top result. In another example, the query is constructed with the goal of producing the image as one of the top n results, where n can be any number, of which n=3 is a non-limiting example.) Constructing a query with this goal is a way of ensuring that the query is an appropriate match for the image, and is likely to retrieve similar images. It is noted that the query may be constructed with this goal in mind, irrespective of whether the query is executed. Thus, the act of constructing a query that, when executed, retrieves a particular image at or near the top of the search results does not imply that the constructed query has ever been executed, or that the query has been determined to achieve its goal. Thus, the act of constructing a query that, when executed, retrieves a particular image, temporally followed by the act of executing the query, is not an internally inconsistent sequence of actions. The act of constructing such a query merely implies that the query has been constructed toward the goal, but the query may or may not have been executed or tested at that time.

At 306, the query is used to perform a search on an image database. It is at this time that the query may actually be executed. It is noted that the automatic identification of an image within content, the automatic construction of a query to retrieve similar images, and the presentation of the retrieved images in an overlay (such as the overlay described above) has the effect of reducing the user's physical interaction with the computer or other device. For example, the user can perform fewer keystrokes, fewer mouse clicks, and fewer taps, swipes, or other gestures, while still finding images other than those presented in the content that the user is viewing. At 308, an overlay is provided that displays the images retrieved in the search, including, possibly, the original image. An example of what such an overlay may look like is shown in FIG. 2, and is described above. At 310, one or more commands are received from users, where the commands indicate what images are to be shown. For example, with reference to the overlay shown in FIG. 2, a user might select one of the thumbnails, indicating that the user wants to see a large version of the thumbnail that is being clicked. Such clicking is a non-limiting example of a command. At 312, the image that has been clicked is shown.

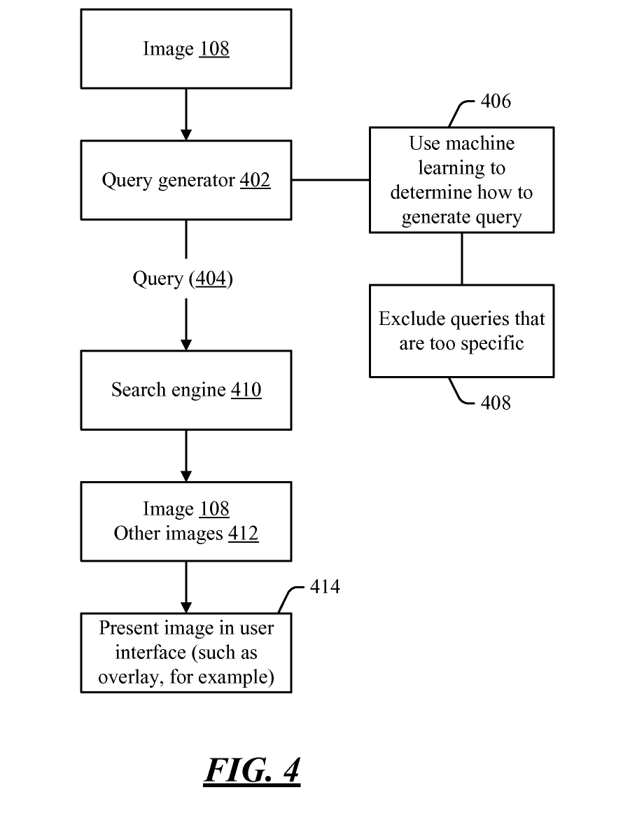

FIG. 4 shows an example scenario in which image viewing is enhanced. Image 108 appears in some content item, such as a web page. Image 108 is provided to query generator 402, which generates query 404. Query 404 is constructed with the goal of creating a query that, when executed by a search engine, will cause image 108 to appear at or near the top of the search results. (As noted above, query 404 can be constructed with this goal regardless of whether query 404 has ever actually been executed to test whether it achieves this goal.)

There are various ways of constructing query 404 to achieve this goal, but one way is to use machine learning (block 406) to find a relationship between images and the queries that retrieve those images, and then to use the learned parameters to generate the query based on the input image. One consideration that may be taken into account in generating the query is to avoid over-specification of the query (block 408). For example, if image 108 is an image of Space Needle that was taken on Oct. 1, 2013, then a search for “Space Needle 10/1/2013” will likely generate that image as a top search result. However, if the goal is to find other images of Space Needle, then that query is too specific; the goal is to find a general query that still generates an image of Space Needle as the top search result.

Once query 404 has been generated (either by the technique described above, or by any other technique), query 404 is provided to search engine 410. Search engine 410 then performs a search on query 404 to find images from a database of images (e.g., a database of images available on the Internet, a proprietary database, etc.). Those images include image 108 and other images 412. The images are then presented in a user interface (block 414). The overlay discussed above in connection with FIG. 2 is a non-limiting example of such a user interface.

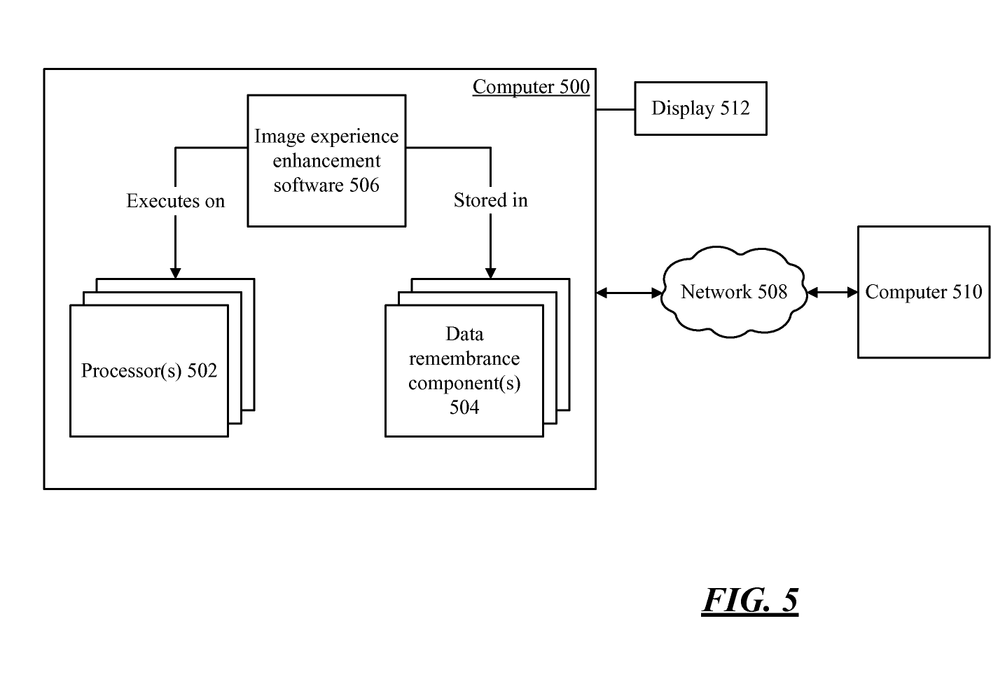

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, a wireless phone, a tablet, a set top box, or another kind of computing device. Data remembrance component(s) 504 are components that are capable of storing data for any length of time. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is image experience enhancement software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on one or more data-remembrance components (such as a hard disk, DVD, ROM, etc.), loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable media. Such instructions, when executed by a computer or other machine (e.g., a phone, a set-top box, an automotive on-screen console, etc.), may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium.

Computer-readable (or device-readable) media includes, at least, two types of computer-readable media, namely computer storage media and communication media. Likewise, device-readable media includes, at least, two types of device-readable media, namely device storage media and communication media.

Computer storage media (or device storage media) includes volatile and non-volatile, removable and non-removable media implemented in any method or technology for storage of information such as computer readable instructions, data structures, program modules, or other data. Computer storage media (and device storage media) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that may be used to store information for access by a computer or other type of device.

In contrast, communication media may embody computer readable instructions, data structures, program modules, or other data in a modulated data signal, such as a carrier wave, or other transmission mechanism. As defined herein, computer storage media does not include communication media. Likewise, device storage media does not include communication media.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

In one example, the subject matter herein provides a method of displaying images to a user, where the method comprises using a processor to perform the acts of: receiving a content page that comprises an image, creating a representative query that retrieves said image, using the query to perform a search on an image database, providing an overlay over the content page, the overlay displaying an image retrieved in the search, the overlay also providing access to other images retrieved in the search, and receiving commands from a user to show images, and showing the images in accordance with said commands. The representative query may be created such that said representative query, when searched by a search engine, returns said image as a top result. The method may further comprise testing the representative query with a search engine to determine whether the representative query returns the image as the top result. The representative query may be created such that the representative query, when searched by a search engine, returns the image as one of the top three results. The method may further comprise using parameters learned by a machine learning component to create the representative query. The method may be created in accordance with a criterion of avoiding over-specification of the representative query.

In another example, the subject matter herein may provide a computer-readable medium comprising executable instructions to display images to a user, the executable instructions, when executed by a computer, causing the computer to perform acts comprising receiving a content page that comprises an image, creating a representative query that retrieves the image, using the query to perform a search on an image database, providing an interface that displays the image and that also provides access to other images retrieved in the search, and receiving commands from a user to show images, and showing the images in accordance with the commands. The representative query may be created such that the representative query, when searched by a search engine, returns the image as a top result. The representative query may be tested with a search engine to determine whether the representative query returns the image as the top result. The representative query may be created such that the representative query, when searched by a search engine, returns the image as one of the top three results. The acts may comprise using parameters learned by a machine learning component to create the representative query. The representative query may be created in accordance with a criterion of avoiding over-specification of the representative query. The interface may comprise an overlay over the content page, the overlay being provided in response to the user's activation of a hook.

In another example, the subject matter herein may provide a system for displaying images to a user, where the system comprises a memory, a processor, and a component that is stored in the memory, that executes on the processor, the component receiving a content page that comprises an image, the component creating a representative query that retrieves the image, the component using the query to perform a search on an image database, the component providing an interface that displays the image and that also provides access to other images retrieved in the search, and the component receiving commands from a user to show images, and showing the images in accordance with the commands. The representative query may be created such that the representative query, when searched by a search engine, returns the image as a top result. The representative query may be tested with a search engine to determine whether the representative query returns the image as the top result. The representative query may be created such that the representative query, when searched by a search engine, returns the image as one of the top three results. The component may use parameters learned by a machine learning component to create the representative query. The representative query may be created in accordance with a criterion of avoiding over-specification of the representative query. The interface may comprise an overlay over the content page, the overlay being provided in response to the user's activation of a hook.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of displaying images to a user, the method comprising:
using a processor to perform acts comprising:
receiving a content page that comprises a image;
creating a representative query that retrieves said image;
using said query to perform a search on an image database;
providing an overlay over said content page, said overlay displaying said image, said overlay also providing access to other images retrieved in said search;
receiving commands from a user to show images; and
showing the images in accordance with said commands.

2. The method of claim 1, said representative query being created such that said representative query, when searched by a search engine, returns said image as a top result.

3. The method of claim 2, said acts further comprising:
testing said representative query with a search engine to determine whether said representative query returns said image as said top result.

4. The method of claim 1, said representative query being created such that said representative query, when searched by a search engine, returns said image as one of the top three results.

5. The method of claim 1, said acts further comprising:
using parameters learned by a machine learning component to create said representative query.

6. The method of claim 1, said representative query being created in accordance with a criterion of avoiding over-specification of said representative query.

7. A computer-readable medium comprising executable instructions to display images to a user, the executable instructions, when executed by a computer, causing the computer to perform acts comprising:
receiving a content page that comprises an image;
creating a representative query that retrieves said image;
using said query to perform a search on an image database;
providing an interface that displays said image and that also provides access to other images retrieved in said search;
receiving commands from a user to show images; and
showing the images in accordance with said commands.

8. The computer-readable medium of claim 7, said representative query being created such that said representative query, when searched by a search engine, returns said image as a top result.

9. The computer-readable medium of claim 8, said acts further comprising:
testing said representative query with a search engine to determine whether said representative query returns said image as said top result.

10. The computer-readable medium of claim 7, said representative query being created such that said representative query, when searched by a search engine, returns said image as one of the top three results.

11. The computer-readable medium of claim 7, said acts further comprising:
using parameters learned by a machine learning component to create said representative query.

12. The computer-readable medium of claim 7, said representative query being created in accordance with a criterion of avoiding over-specification of said representative query.

13. The computer-readable medium of claim 7, said interface comprising an overlay over said content page, said overlay being provided in response to said user's activation of a hook.

14. A system for displaying images to a user, the system comprising:
a memory;
a processor; and
a component that is stored in said memory, that executes on said processor, said component receiving a content page that comprises an image, said component creating a representative query that retrieves said image, said component using said query to perform a search on an image database, said component providing an interface that displays said image and that also provides access to other images retrieved in said search, and said component receiving commands from a user to show images, and showing the images in accordance with said commands.

15. The system of claim 14, said component creating said representative such that said representative query, when searched by a search engine, returns said image as a top result.

16. The system of claim 15, said component testing said representative query with a search engine to determine whether said representative query returns said image as said top result.

17. The system of claim 14, said component creating said representative query such that said representative query, when searched by a search engine, returns said image as one of the top three results.

18. The system of claim 14, component using parameters learned by a machine learning component to create said representative query.

19. The system of claim 4, said component creating said representative query in accordance with a criterion of avoiding over-specification of said representative query.

20. The system of claim 14, said interface comprising an overlay over said content page, said overlay being provided in response to said user's activation of a hook.
